(19) United States
(12) Patent Application Publication
(10) Pub. No.: US 2023/0286866 A1
(43) Pub. Date: Sep. 14, 2023

(54) MIX FOR THE MANUFACTURE OF CERAMIC ARTICLES AND RELATED MANUFACTURING PROCESS

(71) Applicant: SICER S.P.A., Fiorano Modenese (IT)

(72) Inventors: Fabio TERZI, Fiorano Modenese (IT); Sergio MARCACCIOLI, Fiorano Modenese (IT); Giuliano FERRARI, Fiorano Modenese (IT); Margherita FANELLI, Fiorano Modenese (IT); Giovanni PEZZALI, Fiorano Modenese (IT)

(73) Assignee: SICER S.P.A., Fiorano Modenese (IT)

(21) Appl. No.: 18/040,877

(22) PCT Filed: Aug. 6, 2021
(86) PCT No.: PCT/IB2021/057256

§ 371 Date: Feb. 7, 2023

(30) Foreign Application Priority Data
Aug. 7, 2020 (IT) 102020000019720

(51) Int. Cl. C04B 33/13; C03C 8/14; C03C 8/02; C03C 3/087; C04B 33/04; C04B 33/32

(52) U.S. Cl. CPC C04B 33/1315; C03C 8/14; C03C 8/02; C03C 3/087; C04B 33/04; C04B 33/32; C04B 2235/36; C04B 2235/349; C04B 2235/3472; C04B 2235/656

(57) ABSTRACT

A mix for the manufacture of ceramic articles comprising at least two of the following components a frit comprising silicon dioxide present in a concentration by weight, evaluated with respect to the total weight of the frit, comprised between 30% and 75%; calcium oxide or magnesium oxide present in a concentration by weight, evaluated with respect to the total weight of the frit, comprised between 0.01% and 50%; aluminum oxide, present in a concentration by weight, evaluated with respect to the total weight of the frit, comprised between 0.01% and 30%; one or more flux materials comprising tectosilicates; one or more binding materials comprising phyllosilicates.

### TECHNICAL FIELD

The present invention relates to a mix for the manufacture of ceramic articles and to the related manufacturing process.

### BACKGROUND ART

Generally speaking, ceramic mixes comprise a mixture of raw materials consisting of three main components which can be subdivided into a structural component, a plastic component and a flux component.

The structural component typically consists of quartz or glass, the latter being the amorphous phase of the mix.

In parallel, the plastic component comprises clays and the flux component comprises feldspars.

As is well known, in order to obtain a ceramic article with predefined mechanical properties, it is necessary to fire the mix itself.

For this purpose, the firing processes of ceramic mixes consist of heat treatments at temperatures above 600° C.

Firing is a fundamental operation in the technological process of manufacturing ceramic articles as it determines the formation of the ceramic material, transforming the raw materials of the mix into new crystalline and vitreous compounds that give the fired ceramic article special mechanical and aesthetic properties.

These temperatures cause chemical reactions between the components of the mix, including decomposition reactions and phase transitions.

At the end of the firing cycle, the chemical and physical transformations which the ceramic mix undergoes result in the formation of free crystalline silica in the form of quartz or cristobalite.

Nevertheless, it should be underlined that free silica in the form of quartz powder or cristobalite has been included by the International Agency for Research on Cancer in group 1 of carcinogens for humans.

It is therefore clear that the presence of crystalline free silica in ceramic articles such as ceramic tiles, furniture, tableware and sanitary ware poses a high risk to human health.

Further details regarding the risks of crystalline free silica to human health can be found in “Comparison of Hazard Communication Requirements OSHA Hazard Communication Standard 29 CFR 1910.12001(HCS) Globally Harmonized System (GHS)” (https://www.osha.gov/dsg/hazcom/ghoshacomparison.html) issued by Occupational Safety and Health Administration.

In addition, ceramic mixes of known type having the aforementioned drawbacks are described in patent documents no. JP2007197294, US2005/0242477, U.S. Pat. No. 188,660, 2,233,575, 5,028,569, 5,583,079, 5,814,572, 5,830,251, U.S. Ser. No. 10/392,295, WO2011030366, WO2014068301.

In addition, EP06772633 describes a substrate comprising a vitreous phase and a crystalline phase dispersed therein and containing corundum crystals deposited by the vitreous phase as the main ingredient of the crystalline phase.

In addition, said substrate comprises kaolinitic clays without, however, providing any teaching or suggestion to reduce the crystalline free silica content.

Similarly, US20180186687 and DE4021288 describe ceramic substrates having the same limitations and the same drawbacks as the inventions described in the foregoing patent documents, i.e., they do not provide any teaching aimed at reducing the crystalline free silica content.

### DESCRIPTION OF THE INVENTION

The main aim of the present invention is to provide a mix for the manufacture of ceramic articles and a related manufacturing process, which makes it possible to obtain ceramic articles having a crystalline free silica content significantly reduced compared to ceramic articles obtained with mixes of known type.

Within this aim, one object of the present invention is to provide a mix for the manufacture of ceramic articles and a related manufacturing process which enables the manufacture of ceramic articles which are safe for human health.

Another object of the present invention is to devise a mix for the manufacture of ceramic articles and a related manufacturing process which allows overcoming the drawbacks mentioned above of the prior art within the scope of a simple, rational, easy and effective to use as well as affordable solution.

The objects set out above are achieved by the present mix having the characteristics of claim 1.

Furthermore, the objects set out above are achieved by the present manufacturing process for the manufacture of a ceramic article having the characteristics of claim 13.

In addition, the objects set out above are achieved by the present ceramic article having the characteristics of claim 15.

### BRIEF DESCRIPTION OF THE DRAWINGS

Other characteristics and advantages of the present invention will be more apparent from the description of a preferred, but not exclusive embodiment of a ceramic mix and a related manufacturing process, illustrated by way of an indicative, yet non-limiting example, in the attached tables of drawings wherein:

FIG. 1 shows a comparative diffractogram between the ceramic mix according to the present invention and a ceramic mix of known type.

### EMBODIMENTS OF THE INVENTION

In a first aspect, the present invention relates to a mix for the manufacture of ceramic articles.

It is specified that within the scope of the present disclosure, the expressions “ceramic article” or “ceramic material” relate to materials that are optionally also vitreous, such as glass-ceramics, or agglomerates.

Preferably, the ceramic article is selected from the group comprising: ceramic tiles, furniture, tableware, sanitary ware and technical ceramics.

In detail, tiles can be, e.g., unfired tiles, fired tiles, stoneware, porcelain stoneware, mono-porous ceramic, single-fired ceramic, double-fired ceramic, klinker, third-fired and fourth-fired.

In addition, the term “tiles” relates indiscriminately to tiles for home, commercial, industrial use as well as service use of various kinds, which can be employed as floor, exterior wall and interior wall coverings.

Tableware, in turn, can be unfired tableware and fired tableware and comprises household or furnishing items such as crockery, kitchen tops and parts of furniture.

Sanitary ware comprises, e.g., sanitary ware, sinks and washbasins, shower trays.

At the same time, it is specified that the expression “technical ceramics” relates to materials used for the manufacture of components for the mechanical and biomedical sector.

Ceramic articles comprise a main body covered with one or more layers of material selected alternatively from: ceramic, vitreous or organic.

In the context of the present disclosure, the term “agglomerates” relates to tiles or slabs made of inorganic material of the quartz or glass type, which form a coherent material thanks to the use of an inorganic or organic polymeric binding material.

In addition, it is specified that in the context of the present disclosure, the concentrations by weight described therein are with reference to the dry mix before firing.

The mix according to the present invention comprises at least two of the following components:
a frit comprising:
   silicon dioxide present in a concentration by weight, evaluated with respect to the total weight of the frit, comprised between 30% and 75%;
   calcium oxide or magnesium oxide present in a concentration by weight, evaluated with respect to the total weight of the frit, comprised between 0.01% and 50%;
   aluminum oxide, present in a concentration by weight, evaluated with respect to the total weight of the frit, comprised between 0.01% and 30%;
one or more flux materials comprising tectosilicates;
one or more binding materials comprising phyllosilicates.

According to the invention, at least two of the aforementioned components are present in the following concentrations by weight, the frit is present in a concentration by weight, evaluated with respect to the total weight of the dry mix, comprised between 60% and 90%, the one or more flux materials are present in a concentration by weight, evaluated with respect to the total weight of the dry mix, comprised between 0% and 40% and the one or more binding materials are present in a concentration by weight, evaluated with respect to the total weight of the dry mix, comprised between 0% and 40%.

Preferably, the frit comprises barium oxide present in a concentration by weight, evaluated with respect to the total weight of the dry mix, comprised between 0.01% and 50%.

Furthermore, the frit comprises at least one of: sodium oxide, potassium oxide, lithium oxide, zirconium oxide.

Preferably, sodium oxide or potassium oxide are present in a concentration by weight, evaluated with respect to the total weight of the frit, of less than 30%.

Conveniently, lithium oxide is present in a concentration by weight, evaluated with respect to the total weight of the frit, of less than 10%.

Advantageously, zirconium oxide is present in a concentration by weight, evaluated with respect to the total weight of the frit, of less than 30%.

It is of paramount importance to note that the aforementioned components are free of kaolinitic clay.

In detail, phyllosilicates are free of kaolinitic minerals.

According to a preferred embodiment, the mix according to the invention comprises a frit, one or more flux materials and one or more binding materials.

It cannot however be ruled out from the scope of the present disclosure that the mix comprises:
a frit and one or more flux materials; or
a frit and one or more binding materials; or
one or more flux materials and one or more binding materials.

According to the invention, when heated to temperatures above 600° C., these components react with each other to form a ceramic article having a concentration by weight of free crystalline silica, evaluated with respect to the total weight of the ceramic article, of less than 1%.

It should be specified that in the present disclosure, the expression “when heated to temperatures above 600° C., these components react with each other” relates to the chemical reactions in which the components of the mix are involved during the firing phase thereof.

In particular, the aforementioned chemical reactions consist of:
decomposition reactions of the mix components with release of H₂O and CO₂, sulfur oxides and nitrogen oxides;
phase transitions
solid-solid reactions;
solid-liquid reactions;
liquid-liquid reactions;
sintering reactions.

Surprisingly, the synergistic combination of the components of the mix according to the present invention enables the manufacture of a ceramic article substantially free of crystalline free silica.

In this regard, preferably, the ceramic article has a concentration by weight of crystalline free silica, evaluated with respect to the total weight of the ceramic article, of less than 0.1%.

It should be noted that in the context of the present disclosure, the term “frit” relates to an amorphous mixture comprising silicate glass obtained by melting the raw materials and subsequent rapid cooling, also by casting in water.

Furthermore, the expression “one or more flux materials” relates to the presence within the mix of one or more components either belonging to the same mineralogical type or belonging to different mineralogical types and which allow the maximum heat treatment temperatures of ceramic articles to be lowered, allowing chemical reactions to take place and facilitating the formation of a vitreous phase.

More in detail, the one or more flux materials consist of feldspars.

In addition, the expression “one or more binding materials” relates to the presence of one or more components, in this case phyllosilicates, either belonging to the same mineralogical type (e.g. montmorillonite) or belonging to different mineralogical types (e.g. montmorillonite and hectorite) and which confer plasticity to the ceramic article by increasing the modulus of rupture of the ceramic article whether this is pressed or dried.

Additionally, the one or more binding materials are present in a concentration by weight, evaluated with respect to the total weight of the mixture, of less than 21%.

Preferably, the one or more binding materials consist of phyllosilicates.

In detail, the phyllosilicates comprise one or more minerals belonging to the smectite group.

Preferably, the aforementioned minerals belonging to the smectite group comprise montmorillonite and hectorite.

It is specified that the raw materials comprising high percentages of smectites are commercially known as bentonites.

Preferably, the smectites are present in a concentration by weight, evaluated with respect to the total weight of the one or more binding materials, above 5%, preferably above 65%.

It should be noted that the mix comprises one or more minerals present in a concentration by weight, evaluated with respect to the total weight of the mix, comprised between 0% and 30%.

It is specified that in the context of the present disclosure “one or more minerals” relates to the presence within the mix of one or more minerals either belonging to the same mineralogical type (e.g. wollastonite) or belonging to different mineralogical types (e.g. wollastonite and pseudowollastonite).

Preferably, the one or more minerals are selected from the list comprising: cyclosilicates, inosilicates, iron oxides, titanium oxides, zirconium oxides, silicon oxides, aluminum oxides and zirconium silicate.

In detail, the cyclosilicates comprise pseudowollastonite and the inosilicates comprise wollastonite.

In addition, the mix according to the invention comprises one or more additives selected from the list comprising: toughening agents and rheology modifiers.

The aforementioned additives are present in a concentration by weight, evaluated with respect to the total weight of the mix, comprised between 0% and 1%.

The toughening agents are adapted to improve the tensile strength of the ceramic article whether pressed or dried.

Preferably, the toughening agents are organic and/or inorganic in nature.

By way of example, the toughening agents are selected from the list comprising: starches, sugars, cellulose, sulfonates lignin, vinyl polymers, acrylic polymers and naphthalene sulfonates.

In addition, one or more rheology modifiers are adapted to allow maintaining viscosity, density and surface tension values suitable for an efficient grinding process of the mix components.

Preferably, the rheology modifiers are organic and/or inorganic in nature.

By way of example, the rheology modifiers are selected from the list comprising: alkali metal polyphosphates, alkaline earth metal polyphosphates.

It should be noted that the characteristics of the embodiments described with reference to one aspect of the present invention are intended to apply equally to other aspects of the invention described herein, even if not explicitly repeated.

By way of example, four formulations of the mix according to the present invention are set forth below.

### EXAMPLES

These formulations represent a comparison between formulations of known type (formulation 1 and 2) and formulations according to the present invention (formulation 3 and 4).

From this comparison it is clear that the presence of kaolinitic clays determines a percentage by weight of free crystalline silica, evaluated with respect to the total weight of the ceramic article, considerably higher than 1%.

Formulation 1

| COMPONENTS | % w/w |
|---|---|
| Frit | 80 |
| Clay | 20 |
| Kaolin | / |
| Feldspar | / |
| Free crystalline silica fraction | >1 |
| Modulus of rupture | 45 |

Formulation 2

| COMPONENTS | % w/w |
|---|---|
| Frit | 80 |
| Bentonite | / |
| Kaolin | 20 |
| Feldspar | / |
| Free crystalline silica fraction | >1 |
| Modulus of rupture | / |

Formulation 3

| COMPONENTS | % w/w |
|---|---|
| Frit | 70 |
| Bentonite | 15 |
| Kaolin | / |
| Feldspar | 15 |
| Free crystalline silica fraction | <0.1 |
| Modulus of rupture | 20 |

Formulation 4

| COMPONENTS | % w/w |
|---|---|
| Frit | 80 |
| Bentonite | 20 |
| Kaolin | / |
| Feldspar | / |
| Free crystalline silica fraction | <0.1 |
| Modulus of rupture | 27 |

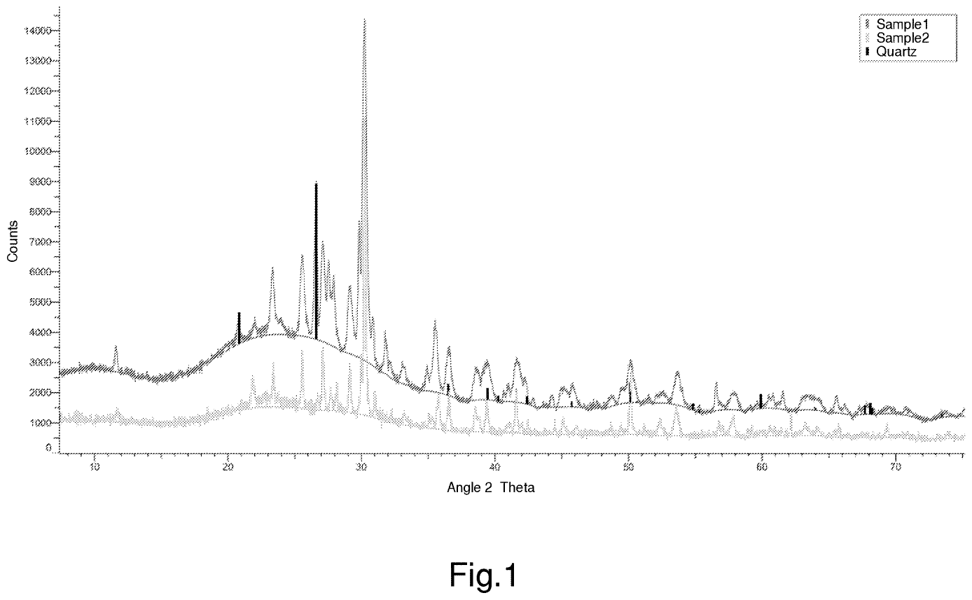

It should be pointed out that FIG. 1 shows a diffractogram relating to a comparative analysis of the data obtained by X-ray diffraction between two samples (sample 1 and sample 2) of mix.

In detail, sample 1 consists of the formulation 2 described above.

At the same time, sample 2 consists of the formulation 4 described above.

By observing the graph in FIG. 1, it is clearly evident that the use of a traditional mix, in the case of sample 1, consisting substantially of kaolinitic clays, determines a concentration of free crystalline silica higher than 6%.

On the contrary, the use of the mix according to the present invention and in which bentonite is present determines a concentration by weight of crystalline free silica, evaluated with respect to the total weight of the manufactured article, lower than 1%, preferably lower than 0.1%.

By way of example, a qualitative and quantitative analysis of the composition of frit (Table 1), feldspars (Table 2) and bentonite (Table 3) is given below.

This analysis was carried out on samples manufactured using the following process:
weighing of the raw materials and semi-finished articles;
addition of water, toughening agent (Lamberti Tenagreen 0465, 1% of the solid mass), rheology modifier (Na tripolyphosphate, 1% of the solid mass);
grinding for 30 minutes with a planetary mill;
drying of the suspension in an oven at 100° C. for 2 hours.
humidification of the dried powder (humidity reached 5% w/w);
pressing of the powder from a 110×55×7 mm specimen at 400 kg/cm2;
firing in a roller kiln with a firing cycle for stoneware (maximum temperature reached 1200° C., firing time 48 minutes).

TABLE 1
Frit

| Component | % w/w |
|---|---|
| Silicon oxide | 67 |
| Aluminum oxide | 3.2 |
| Iron oxide | <0.1 |
| Titanium dioxide | <0.05 |
| Calcium oxide | 20.6 |
| Magnesium oxide | 3.7 |
| Sodium oxide | 0.4 |
| Potassium oxide | 5.0 |
| Total clay minerals | / |
| Feldspars | / |
| Quartz | / |

TABLE 2
Feldspars

| Component | % w/w |
|---|---|
| Silicon oxide | 66.5 |
| Aluminum oxide | 17.0 |
| Iron oxide | <0.05 |
| Titanium dioxide | <0.05 |
| Calcium oxide | / |
| Magnesium oxide | / |
| Sodium oxide | 0.7 |
| Potassium oxide | 14 |
| Total clay minerals | / |
| Feldspars | 94 |
| Quartz | / |

TABLE 3
Bentonite

| Component | % w/w |
|---|---|
| Silicon oxide | 71 |
| Aluminum oxide | 14 |
| Iron oxide | 1 |
| Titanium dioxide | 0.1 |
| Calcium oxide | 2.4 |
| Magnesium oxide | 2.4 |
| Sodium oxide | 1.1 |
| Potassium oxide | 0.9 |
| Total clay minerals | >93 |
| Feldspars | 10-15 |
| Smectites | 80-85 |
| Quartz | 6-8 |

In a second aspect, the present invention relates to a process for the manufacture of a ceramic article.

The process comprises at least the following phases:
supply of a mix according to the present invention;
firing of the mix at a temperature above 600° C. to obtain a ceramic product;
   wherein the ceramic article has a concentration by weight of crystalline free silica, evaluated with respect to the total weight of the mix, below 1%.

Preferably, the aforementioned ceramic article obtained by the process according to the present invention has a concentration by weight of crystalline free silica, evaluated with respect to the total weight of the article, of less than 0.1%.

In detail, the supply phase comprises a step of introducing at least two of the frit, the one or more flux materials and the one or more binding materials into a grinding mill.

In the present case, the supply phase comprises a step of introducing the frit, the one or more flux materials and the one or more binding materials.

Subsequently, the supply phase comprises a hydration step consisting in the introduction of water inside the grinding mill. This way, grinding takes place in a humid environment.

Next, the supply phase comprises a step of adding one or more additives.

At the end of the supply phase, the process comprises a phase of grinding the components of the mix.

The grinding phase mentioned above is adapted to homogenize the mix and to reduce the average particle diameter of each component.

Following the grinding phase, the process comprises a phase of atomization of the mix which is adapted to allow the removal of most of the water present therein and obtain a granular mix.

The powdery mix is, therefore, treated in order to allow the formation of raw articles.

To this end, the process comprises a pressing phase of the aforementioned powdery mix.

The pressing phase is either continuous or discontinuous.

It cannot be ruled out from the scope of the present disclosure that, as an alternative to the pressing phase, the raw article is obtained by casting or extrusion of suspensions or plastic masses of the ground components of the mix.

After the pressing phase, the process comprises a phase of drying the mix at a temperature above 80° C.

Preferably, the drying phase is carried out at a temperature comprised between 100° C. and 200° C. and has a duration of between 5 minutes and 30 minutes.

The synergistic combination of the pressing phase and the drying phase is adapted to ensure that the dried ceramic article has a modulus of rupture of at least 26 kg/cm′ in accordance with the ISO 10545-4 standard.

At this point, the dried ceramic article is fired.

Preferably, the firing phase is carried out using continuous or discontinuous kilns.

During the firing phase, the components of the mix undergo chemical reactions adapted to modify the chemical-physical properties of the mix to obtain a ceramic article.

In detail, the aforementioned chemical reactions comprise:
decomposition of the components of the mix with the release of H₂O and CO₂, sulfur oxides and nitrogen oxides;
phase transitions;
solid-solid reactions;
solid-liquid reactions;
liquid-liquid reactions;
sintering reactions.

In a third aspect, the present invention relates to a ceramic article obtainable from the previously described process and having a concentration by weight of crystalline free silica, evaluated with respect to the total weight of the article, of less than 1%, preferably less than 0.1%.

Preferably, the aforementioned article has a modulus of rupture greater than or equal to 200 kg/cm².

Advantageously, the aforementioned dried article has a modulus of rupture greater than 26 kg/cm².

Furthermore, the ceramic article according to the present invention has water absorption of less than 0.2% w/w, a shrinkage value following the firing process of less than 11%, preferably less than 8%.

It has in practice been ascertained that the present invention achieves the intended objects.

It is underlined that the particular solution of providing for the synergistic combination of at least two of the frit, the one or more flux materials and the one or more binding materials allows the manufacture of a ceramic article having crystalline free silica present in a concentration by weight, evaluated with respect to the total weight of the article, of less than 1%, preferably less than 0.1%.

In detail, the synergistic combination at least between the frit and the one or more minerals belonging to the smectite group surprisingly makes it possible to manufacture ceramic articles which are safe for human health and substantially free of carcinogenic components.

1. A mix for manufacture of ceramic articles, wherein said mix includes at least two components of the following components:
a frit comprising:
silicon dioxide present in a concentration by weight, evaluated with respect to the total weight of the frit, comprised between 30% and 75%,
calcium oxide or magnesium oxide present in a concentration by weight, evaluated with respect to the total weight of the frit, comprised between 0.01% and 50%, and
aluminum oxide, present in a concentration by weight, evaluated with respect to the total weight of the frit, comprised between 0.01% and 30%;
one or more flux materials comprising tectosilicates;
one or more binding materials comprising phyllosilicates; wherein
said at least two components are present in the following concentrations by weight, said frit is present in a concentration by weight, evaluated with respect to the total weight of the dry mix, comprised between 60% and 90%, said one or more flux materials are present in a concentration by weight, evaluated with respect to the total weight of the dry mix, comprised between 0% and 40% and said one or more binding materials are present in a concentration by weight, evaluated with respect to the total weight of the dry mix, comprised between 0% and 40% and said components for heating at temperatures above 600° C. react with each other to form a ceramic article having a concentration by weight of crystalline free silica, evaluated with respect to the total weight of the product, less than 1%.

2. The mix according to claim 1, wherein said phyllosilicates comprise one or more minerals belonging to the smectite group.

3. The mix according to claim 1, wherein said one or more minerals belonging to the smectite group comprise at least one of either montmorillonite or hectorite.

4. The mix according to claim 1, wherein said one or more minerals belonging to the smectite group are present in a concentration by weight, evaluated with respect to the total weight of said one or more binding materials, above 5%.

5. The mix according to claim 1, wherein said one or more minerals belonging to the smectite group are present in a concentration by weight, evaluated with respect to the total weight of said one or more binding materials, above 65%.

6. The mix according to claim 1, wherein one or more minerals present in a concentration by weight, evaluated with respect to the total weight of the dry mix, comprised between 0% and 30%.

7. The mix according to claim 1, wherein said one or more minerals are selected from the list comprising: cyclosilicates, inosilicates, iron oxides, aluminum oxides, silicon oxides, zirconium oxides, zirconium silicates.

8. The mix according to claim 1, wherein said cyclosilicates comprise pseudowollastonite and said inosilicates comprise wollastonite.

9. The mix according to claim 1, wherein one or more additives selected from the list comprising: tougheners and rheology modifiers, said one or more additives being present in a concentration by weight, evaluated with respect to the total weight of the dry mix, comprised between 0% and 1%.

10. The mix according to claim 1, wherein said one or more binding materials are present in a concentration by weight, evaluated with respect to the total weight of the dry mix, of less than 21%.

11. The mix according to claim 1, wherein said components are free of kaolinitic clay.

12. The mix according to claim 1, wherein said frit comprises barium oxide present in a concentration by weight, evaluated with respect to the total weight of the dry mix, comprised between 0.01% and 50%.

13. The mix according to claim 1, wherein said frit comprises at least one of: sodium oxide, potassium oxide, lithium oxide, zirconium oxide.

14. The mix according to claim 1, wherein said sodium oxide or potassium oxide are present in a concentration by weight, evaluated with respect to the total weight of the frit, of less than 30%.

15. The mix according to claim 1, wherein said lithium oxide is present in a concentration by weight, evaluated with respect to the total weight of the frit, of less than 10%.

16. The mix according to claim 1, wherein said zirconium oxide is present in a concentration by weight, evaluated with respect to the total weight of the frit, of less than 30%.

17. A process for the manufacture of ceramic articles comprising:
supply of a mix according to claim 1; and
firing of said ceramic mix at a temperature above 600° C. to obtain a ceramic product; wherein
said ceramic article has a concentration by weight, evaluated with respect to the total weight of the article, below 1%.

18. The process according to claim 17, further comprising: at least one drying phase of said ceramic mix at a temperature above 80° C.

19. A ceramic article obtainable from the process according to claim 17, further comprising a crystalline free silica content below 1%.

20. A ceramic article according to claim 19, further comprising a modulus of rupture above 200 kg/cm².
